(19) United States
(12) Patent Application Publication
(10) Pub. No.: US 2023/0196456 A1
(43) Pub. Date: Jun. 22, 2023

(54) Computational Method for Building, and Graphical User Interface for Assisting in the Construction of, Maximally Concentrated Broad-Based Security Indices

(71) Applicant: The Economist`s Advocate, Inc., Milton, MA (US)

(72) Inventor: Matthew Krepps, Milton, MA (US)

(21) Appl. No.: 17/556,000

(22) Filed: Dec. 20, 2021

(51) Int. Cl. G06Q 40/04; G06Q 30/00; G06F 3/0482

(52) U.S. Cl. CPC G06Q 40/04; G06Q 30/018; G06F 3/0482

(57) ABSTRACT

Methods, systems, and apparatus, including computer programs encoded on a computer storage medium, for constructing a maximally concentrated broad-based security index (“BBSI”). In one aspect, a method comprises: receiving selection data specifying a security and a concentration of the security; accessing previously selected securities and their respective concentrations; accessing a plurality of constraints for constructing a BBSI; determining whether a conflict exists among the concentrations of the security and the previously selected securities with the BBSI constraints; when a conflict exists, prompting a user for input to resolve the conflict; when there is no determined conflict, determining whether the concentrations can be increased without violating the BBSI constraints; storing the data specifying a concentration of the security; when the concentrations can be increased, prompting the user to increase the concentrations; and when the user selects to increase the concentrations, storing the increased concentrations.

### BACKGROUND

Real money security picking contests for investors have never been offered legally in the United States. Prior entrants have been shut down by federal regulators for, inter alia, offering security-based swaps.

### SUMMARY

This specification describes a system implemented as computer programs on one or to more computers in one or more locations that processes digital data to construct a maximally concentrated security index.

According to an aspect, a computer implemented method for generating a maximally constructed broad-based security index, the method comprising: receiving, through a graphical user interface, selection data specifying selection of a visual representation of a security and further specifying a concentration of the security, with the selection data being associated with a key that uniquely identifies a user associated with the selection data; accessing, from a hardware storage device, one or more data records that are keyed to the key, with the one or more data records structured to specify one or more previously selected securities and one or more respective concentrations of the one or more previously selected securities; accessing, from the hardware storage device, one or more data structures specifying a plurality of constraints for constructing a broad-based security index (index or “BBSI”); parsing, by a parser of the data processing system, the one or more data records to identify, based on the structure, data specifying the one or more previously selected securities and data specifying the one or more respective concentrations; based on the parsed data, determining, by the data processing system, whether a conflict exists among the concentration of the security with respective concentrations of the previously selected securities and the BBSI constraints; when a conflict exists, prompting, through the graphical user interface, a user for input to resolve the conflict; when there is no determined conflict, determining whether the concentration of the security or at least one of the one or more concentrations of the previously selected securities can be increased, relative to an original concentration of the security, without violating the BBSI constraints; storing, in the hardware storage device, the one or more keyed data records structured with data specifying a concentration of the security; when at least one of the one or more concentrations of the security and the one or more previously selected securities can be increased without violating the BBSI constraints, prompting, through the graphical user interface, the user to increase the at least one of the one or more concentrations of the security and the one or more previously selected securities; and when the user selects to increase the at least one of the one or more concentrations of the security and the one or more previously selected securities, storing, in the hardware storage device, the one or more keyed data records structured with data specifying at least one of the one or more increased concentrations.

In some implementations, the BBSI constraints specify: the BBSI has ten or more component securities; no single component security comprises more than 30 percent of the index's weighting; the five highest weighted component securities together comprise no more than 60 percent of the index's weighting; and the lowest weighted component securities comprising, in the aggregate, 25 percent of the index's weighting have an aggregate dollar value of average daily trading volume (ADTV) of $50 million or more (or in the case of an index with 15 or more component securities, $30 million or more).

In some implementations, the method further comprises: generating, by the data processing system, a contest in which a plurality of entrants construct respective entrant specific BBSIs, with each entrant corresponding to one or more data structures (“entrant data structures”) stored in a hardware storage device, wherein the contest has a start time, an end time, and a predetermined monetary budget for the entrant specific BBSIs, wherein the method includes: prior to the start time, generating, by the data processing system, a graphical user interface with a plurality of input controls for receiving input specifying one or more securities from a pre-specified selection universe for inclusion in the entrant specific BBSI, with the graphical user interface being accessible before the start time and being inaccessible after the start time; and for a particular entrant data structure, upon receipt of input from the input controls, updating the entrant data structure with data specifying names of selected securities and concentrations of selected securities; determining whether a conflict exists among concentrations of securities in the entrant data structure and the BBSI constraints; and if a conflict exists, receiving input to resolve the conflict; and at the end time, determining a rank ordering of the entrant data structures in accordance with respective monetary values of the entrant data structures.

In some implementations, the method further comprises: causing rendering, on a client device, of one or more graphical user interfaces with one or more visual representations of results of free play contestants or real money contestants, with a real money contestant being an entrant that is a retail player who meets the definition of Eligible Contract Participant (as defined in the Commodity Exchange Act Section 1a(18) and as required by Section 2(e) of the Commodity Exchange Act) and who will be permitted to enter contests with real money entry fees and be eligible for real money prizes (i.e., contestants who have at least a minimum of $10 million invested on a discretionary basis) and with a free play contestant being an entrant that is a retail player who does not meet the definition of Eligible Contract Participant (as defined in the Commodity Exchange Act Section 1a(18) and as required by Section 2(e) of the Commodity Exchange Act) and who will not be permitted to enter contests with real money entry fees nor be eligible for real money prizes (i.e., contestants who do not have at least a minimum of $10 million invested on a discretionary basis).

In some implementations, the BBSI constraints specify: the BBSI has nine or more component securities; no single component security comprises more than 30 percent of the index's weighting; all of the component securities are registered under section 12 of the Exchange Act; and each component security is both one of the 750 securities with the largest market capitalization and one of the 675 component securities with the largest dollar value of the average daily trading volume (“ADTV”).

In some implementations, the method further comprises: prompting, through the graphical user interface, the user to select a prepopulated template from one or more prepopulated templates, where each prepopulated template of the one or more prepopulated templates specifies a plurality of concentrations for completing a BBSI for the user and that satisfy the constraints for constructing a BBSI; and if the user selects the prepopulated template: accessing, from the hardware storage device, a plurality of data records that are structured to specify the plurality of concentrations and, for each of the plurality of concentrations, a respective security that is to be selected by the user; prompting the user, through the graphical user interface, to select, for each of the plurality of concentrations, a respective security for the concentration from a set of securities that satisfy the BBSI constraints; receiving, through the graphical user interface, selection data specifying selection of a visual representation of the selected respective securities, with the selection data being associated with the key that uniquely identifies the user associated with the selection data; parsing, by the parser of the data processing system, the plurality of data records to identify, based on the structure, data specifying the selected respective securities and data specifying the plurality of concentrations; and storing, in the hardware storage device, the plurality of keyed data records structured with data specifying the plurality of selected securities and the plurality of concentrations.

In some implementations, the one or more prepopulated templates include a maximally concentrated template.

In some implementations, the one or more prepopulated templates include an equally concentrated template.

In some implementations, the method further comprises: accessing, from an external hardware storage device, real time market data specifying at least, for each security in a security market, a respective price history, a respective trade volume history, and a respective market capitalization; processing the real time market data to determine, for each security in the security market, a respective average daily trading volume (“ADTV”) for the security and a respective correlation coefficient for the security with respect to at least one of the security and the one or more previously selected securities (“real time data”); and based on the parsed data and the real time data, determining, by the data processing system, whether a conflict exists among the concentration of the security with respective concentrations of the previously selected securities and the BBSI constraints.

The following are some of the additional features within this aspect.

Other aspects include computer program products tangibly stored on non-transitory computer readable media and computation systems such as computer systems, computer servers.

The above aspects can include one or more of the following advantages.

In a stock picking contest, users care not only about the mathematical concentration of their respective component holdings, but also about the variance of their stream of expected returns. Other things being equal, a portfolio with a higher variance of expected returns is to be preferred. In other contest settings, maximizing the variance of expected return streams is relatively easy; however, in stock picking contests that task is not susceptible to unaided calculation in the human mind.

With a security selection universe of thousands of securities, and the permissibility of users taking long or short positions with respect to each security, it is well beyond the computational capability of any human to track all of the bilateral cross correlations that would be required to sort securities in descending order based on the absolute value of their cross-correlation with a security previously chosen by a user.

The disclosed methods herein generate a user interface that enables users to build maximally concentrated portfolios that do not breach any of the broad-based security index (“BBSI”) boundary conditions. The constrained optimization problem presented by the simultaneous need to satisfy the BBSI conditions with the conflicting aim of creating the most concentrated index is based on complex patterns and correlations well beyond what could be analyzed by a human or solely in the human mind. Other features and advantages of the invention will become apparent from the following description, and from the claims.

### BRIEF DESCRIPTION OF THE DRAWINGS

FIG. 1 depicts an example of a system for processing digital data to construct a maximally concentrated broad-based security index.

FIG. 2 depicts an example environment of a networked data processing system for constructing a maximally concentrated broad-based security index.

FIG. 3A-B depict examples of graphical user interfaces for conflict resolution and increasing concentrations.

FIG. 4A-C depict examples of graphical user interfaces for selecting securities from prepopulated templates.

FIG. 5 depicts a flow diagram for an example process for processing digital data to construct a maximally concentrated broad-based security index.

FIG. 6 depicts a flow diagram for an example process for conducting a contest.

FIG. 7 depicts an example diagram of computing devices that can be used to implement a system for processing digital data to construct a maximally concentrated security index.

### DETAILED DESCRIPTION

The system described herein facilitates the construction of broad-based security indexes that do not constitute security-based swaps. In particular, this description relates to processing digital data to construct a maximally concentrated security index. A security index (“index” or “portfolio”) includes a set of multiple securities (“securities” or “component securities”). A maximally concentrated security index includes a security index in which a concentration of one or more securities in the security index is increased, relative to an original concentration of that security, while complying with one or more constraints. Generally, a concentration of a security in an index includes a share of the index allocated to the security, e.g., represented by a percentage of the total monetary value of the index. The present disclosure includes a system that enables users to easily construct competitive security indices that serve the dual criteria of: 1) satisfying the Commodity Futures Trading Commission's (CFTC) definition of Broad-Based Security Index (“BBSI”); 2) maximizing the concentration of such security indices without violating the boundary conditions of a BBSI; and 3) maximizing the variance of the expected return stream of an index based on correlations between the highest weighted security or securities and all other securities in the selection universe.

The system, through a graphical user interface, receives a security index associated with a user that includes one or more securities, and determines whether the security index complies with the one or more BBSI constraints. In response to the determination, the system generates a graphical user interface that includes, for each security in the security index, a respective range of concentrations for the security that comply with the one or more BBSI constraints. The user can select, through the graphical user interface and for each security, a concentration for the security from the respective range of BBSI-compliant concentration values. Selecting the maximum concentration from each range of concentrations corresponds to constructing a BBSI-compliant, maximally concentrated security index that includes the same securities as the original BBSI associated with the user.

The simultaneous need to satisfy the BBSI boundary conditions with the conflicting aim of creating the most concentrated index is a constrained optimization problem that is based on complex patterns and correlations well beyond what could be analyzed by a human or solely in the human mind. Solving the constrained optimization problem and generating a user interface for the user to select BBSI-compliant concentrations for the securities enables the user to more easily construct compliant BBSIs.

The methods described herein can be performed locally on any appropriate data processing device, e.g., a central processing unit (“CPU”), a graphical processing unit (“GPU”), or a tensor processing unit (“TPU”), or distributed across multiple appropriate data processing devices, e.g., on a cloud computing system. Performing the methods on, e.g., a GPU, can accelerate the speed at which streamed data is processed to construct the BBSI-compliant, maximally concentrated portfolio, which can enable more real-time simulations and pricing decisions and performance tracking to be executed in real time with regard to real time data. The speed at which streamed data is processed is accelerated, relative to the speed at which streamed data is processed using a standard processor or processing unit.

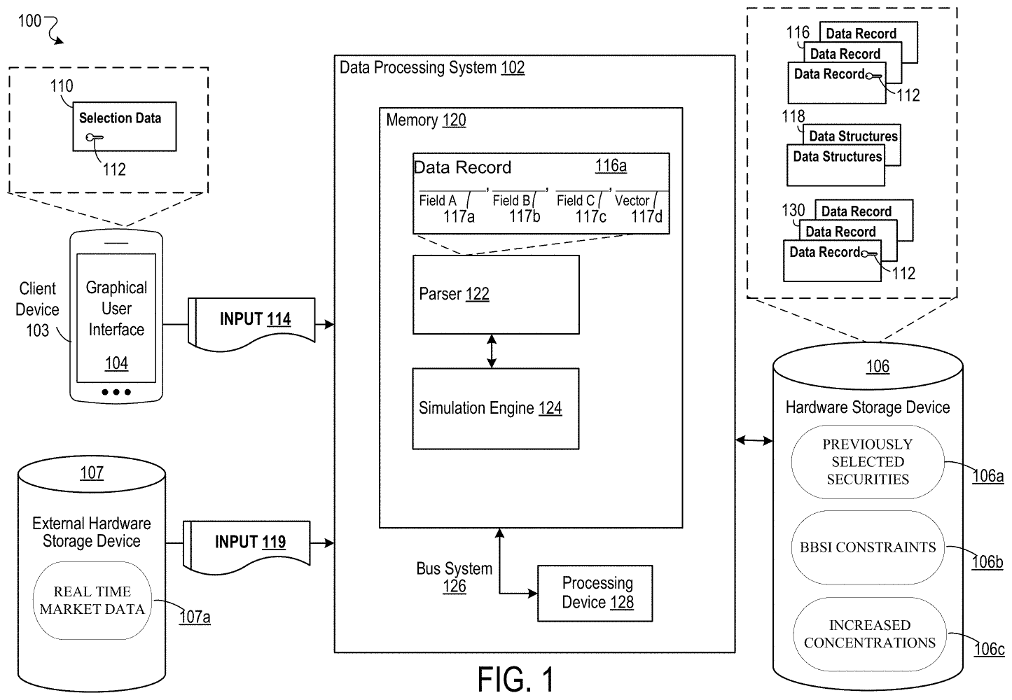

FIG. 1 shows an example system 100 for processing digital data to construct a maximally concentrated broad-based security index. The system 100 is an example of a system implemented as computer programs on one or more computers in one or more locations in which the systems, components, and techniques described below are implemented.

The system 100 processes selection data 110 associated with a key 112 to store one or more keyed data records representing at least in part the selection data 110 in a hardware storage device 106. Generally, selection data includes data specifying a user's interaction and/or selection of one or more portions of a graphical user interface and/or one or more visual representations in a graphical user interface. Generally, a key includes data that uniquely identifies one or more properties of the associated data, e.g., that uniquely identifies a user associated with the data.

The focus of the discussion herein will be on processing the digital data that will be used to construct a maximally concentrated security index that satisfies the CFTC's definition of a BBSI. In general, the system 100 in this implementation is based on a graphical user interface 104 rendered on a display of client device 103, data processing system 102, a hardware storage device 106, and an external hardware storage device 107. The data processing system 102 includes memory 120, parser 122, simulation engine 124, bus system 126, and processing device 128.

In general, the system 100 can process selection data representing multiple securities and respective concentrations. For convenience, the system will be described as processing a security and a concentration of the security. The security can include a “current” security that is a security most recently selected by the user interacting with the graphical user interface 104.

The graphical user interface 104 is configured to receive input 114 and transmit the input 114 to the data processing system 102. The input 114 includes the selection data 110 associated with the key 112 that uniquely identifies a user associated with the selection data 110. The graphical user interface 104 can be displayed on a client device 103, e.g., a mobile device, a tablet, or a computer, and the input 114 can be selected by the user interacting with the graphical user interface 104. For example, the selection data 110 can represent selection of a visual representation of the security and the concentration of the security. The concentration can represent, e.g., a percentage allocation for the security of a total monetary value of the index.

The data processing system 102 is configured to access from the hardware storage device 106 one or more data records 116 that are keyed to the key 112, e.g., data record 116a. The one or more data records 116 are structured to specify one or more previously selected securities 106a and one or more respective concentrations of the one or more previously selected securities. For example, each data record can be structured to include one or more fields, e.g., fields 117a, 117b, 117c, and 117d.

In one example of the data record 116a, the fields 117a-d can correspond respectively to a field A, a field B, a field C, and a vector (or other type of data structure) of numerical values. The field A can specify the key 112 that uniquely identifies the user associated with the selection data 110, e.g., represented by a unique alphanumeric or integer sequence. The field B can specify the previously selected security represented by the data record, e.g., represented by a character sequence corresponding to the name or ticker symbol of the security, or a unique numerical sequence identifying the security. The field C can specify a long flag for the security that indicates a long position in the security, or a short flag for the security that indicates a short position in the security, e.g., represented by an alphanumeric sequence, or, respectively, a 0 or a 1. The vector can specify the concentration of the previously selected security, e.g., a 20% concentration of security ABC. Generally, a long position includes a position in the security that will gain in value when the market price of the security rises, and a short position includes a position in the security that will gain in value when the market price of the security falls. Generally, a market price (“price”) or market value (“value”) of a security is determined in a securities market, where a security market (“market”) is a market in which securities are bought and sold.

In one example, for a portfolio with a monetary value of $1,000,000, a 20% concentration of a security ABC corresponds to an allocation of $200,000 for security ABC.

The data processing system 102 is configured to access from the hardware storage device 106 one or more data structures 118 that specify multiple constraints 106b for constructing a BBSI. The multiple constraints can represent one or more sets of boundary conditions as defined by the CFTC. In this example, the data structures 118 specifying the BBSI constraints 106b are stored in hardware storage device 106 as a set of nodes, with each data structure representing a node and a value of a node representing a BBSI constraint. In this example, the nodes themselves are structured data. Generally, structured data includes data that has been organized into a formatted repository, typically a database, so that its elements can be made addressable for more effective processing and analysis. Given the structure of this data, a data processing system can process this structured data with reduced latency, relative to the latency required to process large volumes of unstructured data. Because the data itself has a pre-specified structure, the parser can quickly identify certain types of data. Additionally, certain portions of the data may reference or point to other data structures. Because the data is structured, the parser can efficiently look up references to other portions of data.

As described in further detail below, these constraints can be broken up into various sets. The data processing system 102 receives input (over an input port of data processing system 102) specifying which set is to be applied to a constructed index (and/or an index being constructed). Based on the specified set, data processing system 102 traverses the nodes stored in hardware storage device 106 to identify which nodes are applicable to a given set. In some examples, the nodes are labeled to specify which set the nodes belong to. In other examples, the contents of the nodes themselves specify which sets the node belongs to. Based on the identified nodes, the data processing system 102 extracts values or contents from the nodes—with the extracted values being in the form of constraints—and applies the constraints to the index being constructed.

In one example, the constraints can include a “set A” of boundary conditions that specify i) the BBSI has ten or more component securities, ii) no single component security comprises more than 30 percent of the index's weighting, iii) the five highest weighted component securities together comprise no more than 60 percent of the index's weighting, and iv) either the lowest weighted component securities comprising, in the aggregate, 25 percent of the index's weighting have an aggregate dollar value of average daily trading volume (“ADTV”) of $50 million or more, or, in the case of an index with 15 or more component securities, $30 million or more. Generally, an ADTV of a security includes the average daily dollar volume of shares traded during a certain period of time, e.g., during a month, six months, or a year. The dollar value of ADTV includes the value in dollars of the number of shares traded during the reference period divided by the number of trading days in that reference period.

In another example, the constraints can include a “set B” of boundary conditions that specify i) the BBSI has nine or more component securities, ii) no single component security comprises more than 30 percent of the index's weighting, iii) all of the component securities are registered under section 12 of the Exchange Act, and iv) each component security is both one of the 750 securities with the largest market capitalization and one of the 675 component securities with the largest dollar value of the ADTV. Generally, a market capitalization of a security includes a monetary value of the security, e.g., determined by multiplying the total number of shares by a price per share of the security.

In yet another example, the constraints can include both the set A of boundary conditions and the set B of boundary conditions, where a security index can satisfy either set A or set B, or both.

In the memory 120 is the parser 122 that is configured to parse the one or more data records 116. Based on the structure of the one or more data records 116, the parser 122 can identify data specifying the one or more previously selected securities and the respective concentrations of the one or more previously selected securities represented by the one or more data records 116. That is, each data record includes structured data. The parser 122 parses the structured data to identify which data is to be applied, e.g., to the constraints. For example, the fields 117a-d can each be of a respective fixed length, e.g., a respective fixed number of bits. The parser 122 can identify the data by parsing each respective fixed length of data and associating the respective data with the corresponding key, security, long or short flag, or concentration of the security.

In another example, the fields 117a-d can be of variable lengths, and separated by unique separate tokens, e.g., a unique sequence of bits that represents that one element ends and the next begins. The parser 122 can parse the data record and identify the respective data between the separate tokens. The data processing system 102 is configured to access from the external hardware storage device 107 real time market data 107a that specify at least, for each security in a security market, a respective price history, a respective trade volume history, and a respective market capitalization.

Generally, a price history of a security includes a price of the security at each of multiple time points over a period of time, e.g. daily opening, closing, high, and low prices over e.g., a month, six months, or a year.

Generally, a trade volume for a security includes a total number of shares of the security that were traded during a given period of time, e.g., a day, a week, or a month, and a trade volume history includes the trade volume at each of multiple time points over a period of time, e.g., a daily trading volume over a month, six months, or a year.

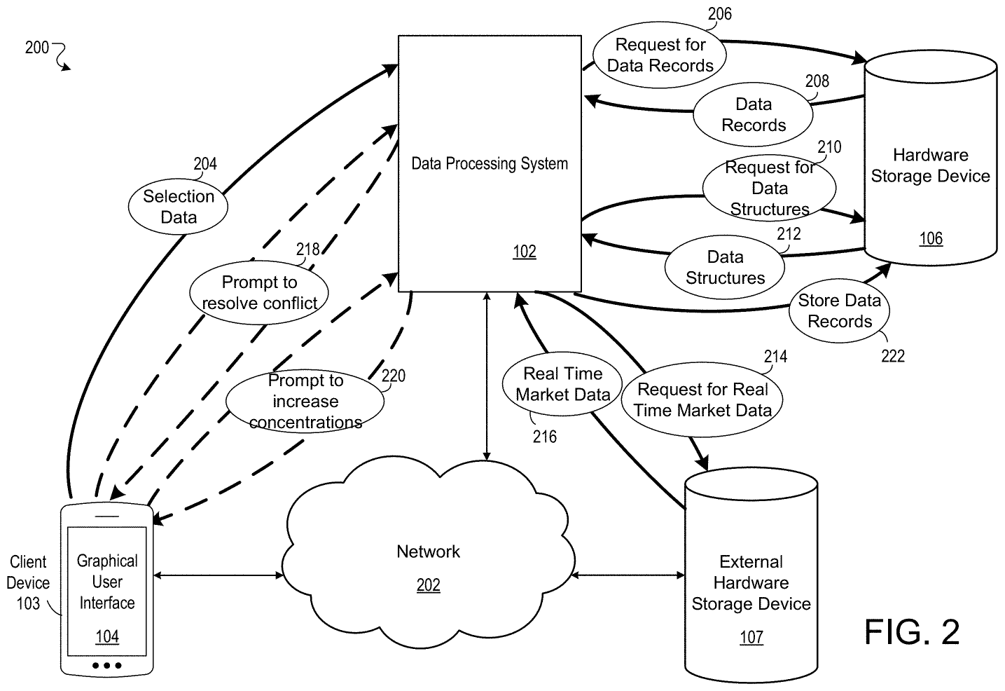

The data processing system 102 can transmit a request to the external hardware system 107, and the external hardware storage device 107 can determine the real time market data 107a, e.g., based on the time that the request is received by the external storage device 107. The external hardware storage device 107 can transmit an input 119 that includes the real time market data 107a to the data processing system 102. The communication can happen over a network, e.g., the internet or other network, as described in further detail below with respect to FIG. 2.

The data processing system 102 can process the real market data 107a included in the input 119 to determine, for each security in the market, the respective ADTV of the security, a respective market capitalization of the security, and a respective correlation coefficient of the security with respect to each of one or more of the security and the one or more of the previously selected securities (to determine “real time data” for the securities). The correlation coefficients can include, e.g., the bivariate correlation coefficient between two respective securities.

For example, the data processing system 102 can determine the respective ADTVs as a time average of the trading volume over a predetermined time period from the past until the present, e.g., the past month, six months, or year. The data processing system 102 can determine the respective correlations using any appropriate method, e.g., Pearson's correlation coefficient formula.

In one example, the data processing system 102 can determine the respective correlation coefficients with respect to the security.

In another example, the data processing system 102 can determine a respective set of correlation coefficients for each security in the market with respect to each of one or more of the security and the previously selected securities with the highest concentrations. The data processing system 102 can determine a respective set of correlation coefficients for the most highly concentrated security, for each of the two securities with the two highest respective concentrations, and so on.

The simulation engine 124 is configured to process the selection data 110, the parsed data identified in the data records 116, the real time data derived from the real time market data 107a, and the BBSI constraints 106b represented by the data structures 118, and to determine whether there is a conflict among the concentration of the security with the concentrations of the one or more previously selected securities according to the BBSI constraints. Generally, a conflict happens when one or more securities violate one or more BBSI constraints.

The simulation engine 124 can process these data and data structures to determine if they satisfy at least one of the one or more sets of constraints, e.g., satisfy either set A or set B, or both. If one or more of the constraints are violated, the data processing system 102 can prompt the user to resolve the conflict, as described below. For example, the simulation engine 124 can process these data for each set of constraints in parallel, in series, or in a decision tree.

In one example, the simulation engine 124 can process these data to determine if they satisfy the constraints for set A in the following order. The simulation engine 124 can determine if each security is unique, and, if not, combine the concentrations of any duplicate securities. The simulation engine 124 can then determine, for the respective concentration of each security, if the concentration is equal to or less than 30, as

1≤sᵢ≤30, (1)

where i indexes the securities in the security index, and sᵢ is the concentration of security i, e.g., represented by a positive integer. If equation (1) is satisfied, the simulation engine 124 can rank order the concentrations in descending order so that for each concentration,

sᵢ≥sᵢ₊₁. (2)

If equation (2) is satisfied, the simulation engine 124 can determine if the portfolio contains at least five securities. If the portfolio contains at least five component securities, the simulation engine 124 can determine whether the cumulative concentration of the five component securities with the highest concentrations is less than or equal to sixty, as

Σᵢ₌₁⁵sᵢ≤60. (3)

If equation (3) is satisfied, the simulation engine 124 can determine if there are between ten and one hundred component securities in the index, as

10≤n≤100, (4)

where n is the number of component securities, e.g., including the security and the one or more previously selected securities. If equation (4) is satisfied, the simulation engine 124 can determine if the cumulative concentration of the concentrations of the securities is equal to one hundred, as

Σᵢ₌₁ⁿsᵢ=100. (5)

If equation (5) is satisfied, the simulation engine 124 can determine, using the real time data, if either the lowest weighted component securities comprising, in the aggregate, 25 percent of the index's concentration have an aggregate dollar value of ADTV of $50 million or more, or, in the case of an index with 15 or more component securities, $30 million or more.

In one example, the simulation engine 124 can process these data to determine if they satisfy the constraints for set B in the following order. The simulation engine 124 can determine if each security is unique, and, if not, combine the concentrations of any duplicate securities. The simulation engine 124 can then determine, for each concentration, if the concentration is equal to or less than 30, as

1≤sᵢ≤30, (6)

where i indexes the securities in the security index, and sᵢ is the concentration of security i, e.g., represented by a positive integer. If equation (6) is satisfied, the simulation engine 124 can determine if there are between nine and one hundred component securities in the index, as

9≤n≤100, (7)

where n is the number of securities, e.g., including the security and the one or more previously selected securities. If equation (7) is satisfied, the simulation engine 124 can determine if the cumulative concentration of the concentrations of the securities is equal to one hundred, as

Σᵢ₌₁ⁿsᵢ=100. (8)

If equation (8) is satisfied, the simulation engine 124 can determine, using the BBSI constraints 106b, if all of the component securities are registered under section 12 of the Exchange Act. If all of the component securities are registered under section 12 of the Exchange Act, the simulation engine 124 can determine, using the real time data, if each component security is both one of the 750 securities with the largest market capitalization and one of the 675 component securities with the largest dollar value of the ADTV.

In one example, the simulation engine 124 can process these data to determine if they satisfy the constraints in the following order. The simulation engine 124 can determine if the securities are unique within the portfolio, and combine any concentrations of securities that have been selected more than once. The simulation engine 124 can determine if the respective concentration of each security is between 1% and 30%. The simulation engine 124 can determine whether there is a minimum of nine securities for set B BBSI constraints, or ten securities for set A BBSI constraints. The simulation engine 124 can determine if the five securities with the highest concentrations have a cumulative concentration of 60% or less. The simulation engine 124 can determine, for the securities with the lowest concentrations, whether the ADTV calculations meet the BBSI requirements. The simulation engine 124 can determine if all the securities are found to be in the set B allowable securities, and evaluate only set B BBSI constraint specific criteria without having to satisfy set A BBSI constraints.

In one example, the simulation engine 124 can process these data to determine if they satisfy each set of constraints in parallel. The simulation engine 124 can determine concurrently if the data satisfy the set A of constraints and if the data satisfy the set B of constraints.

In another example, the simulation engine 124 determines whether these data satisfy the different sets of constraints in series. The simulation engine 124 can process the data to determine if they satisfy set A. If they fail to satisfy set A, the simulation engine 124 can process the data to determine if they satisfy set B.

In another example, the simulation engine 124 can process the data as part of a decision tree. The simulation engine 124 can determine the number of component securities. If the number of component securities is nine, the simulation engine 124 can determine if the data satisfy set B constraints. If the number of component securities is ten or greater, the simulation engine 124 can determine the sum of the concentrations of the five component securities with the highest concentrations. If sum is greater than sixty percent, the simulation engine 124 can determine if the data satisfy set B. Otherwise, the simulation engine can determine if the data satisfy either set A or set B.

The data processing system 102 can transmit, through the bus system 126 to the processing device 128, the instructions from the parser 122 to parse the data, instructions to determine the real time data, and instructions from the simulation engine 124 to determine if the parsed data satisfy the constraints with the real time data. The processing device 128 can perform operations according to the instructions and transmit the result of the operations back through the bus system 126 to memory 120.

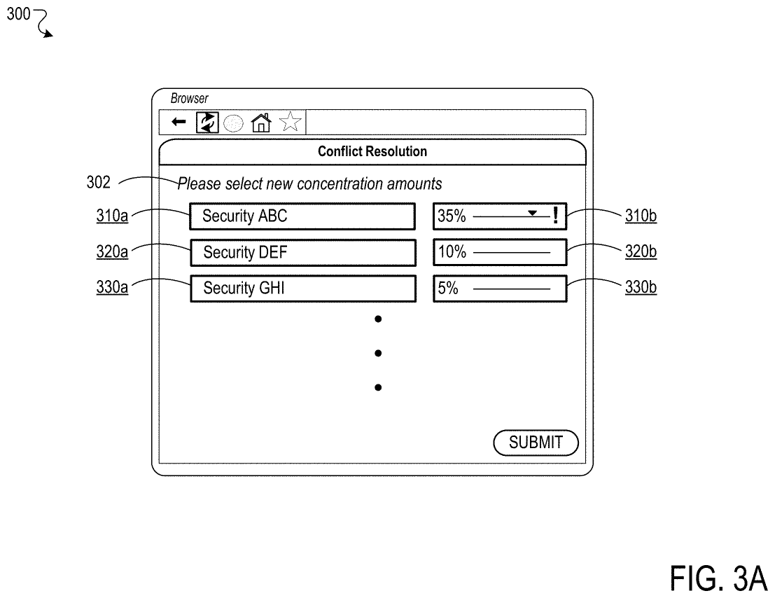

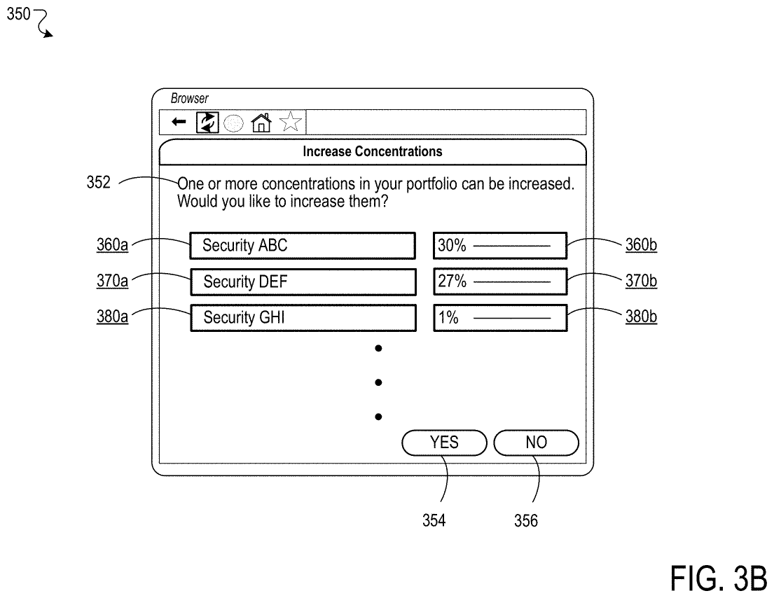

If the simulation engine 124 determines that there is a conflict, the data processing system 102 prompts, through the graphical user interface 104, a user for input to resolve the conflict. The data processing system 102 can send instructions to cause the graphical user interface 104 to display the prompt to the user. The user can select a visual representation of one or more securities and one or more respective concentrations of the one or more securities, and the graphical user interface 104 can transmit an input representing the selection of the visual representation to the data processing system 102. For example, the prompt can include a message requesting the user to resolve the conflict and a menu including fields to select one or more securities and corresponding fields to select one or more respective concentrations, as described in FIG. 3A below.

When there is no determined conflict, the data processing system 102 determines whether the concentration of the security or at least one of the one or more concentrations of the previously selected securities can be increased without violating the BBSI constraints. The simulation engine 124 can process the concentrations of the security and the one or more concentrations of the one or more previously selected securities to determine whether one or more of the concentrations can be increased without violating the BBSI constraints.

For example, the simulation engine 124 can determine that concentrations in a BBSI-compliant prepopulated template are more concentrated than the concentrations of the security and the one or more previously selected securities.

In another example, the simulation engine 124 can determine whether a Herfindahl-Hirschman Index (“HHI”) of the concentrations of the security and the one or more previously selected securities is maximal subject to the BBSI constraints. Generally, the HHI of the concentrations can be determined as,

HHI(S)=Σᵢ₌₁ⁿsᵢ², (9)

where i indexes the component securities, n represents the number of component securities, sᵢ represents the concentration of component security i (e.g., as a positive integer less than or equal to 100), and S represents the set of concentrations {sᵢ}. As illustrative examples, the HHI of a portfolio with a single security with a concentration of 100% is 10000=100², and the HHI of a portfolio with 100 securities with respective concentrations of 1% is 100=100×1².

The simulation engine 124 can determine whether the HHI of the component securities is less than an HHI of a pre-determined maximally concentrated portfolio that 1) includes a number of securities equal to n and 2) is BBSI-compliant (e.g., if n equals 9, the concentrations are still less than 30%, the concentrations sum to 100, etc.). In response to determining that the HHI of the component securities is less than the HHI of the pre-determined maximally concentrated portfolio, then the simulation engine 124 can determine that one or more of the concentrations can be increased.

As illustrative examples for maximally concentrated portfolios subject to set A constraints, the HHI of a portfolio with 45 securities is 1672=30²+27²+43×1².

As illustrative examples for maximally concentrated portfolios subject to set B constraints, the HHI of a portfolio with nine securities 2730=30²+30²+30²+5²+5×1².

In another example, the simulation engine 124 can determine if the security with the highest concentration can be increased without violating the BBSI constraints. Then, the simulation engine 124 can determine if the security with the second highest concentration can be increased without violating the BBSI constraints, and on until the concentration of no security can be increased without violating the BBSI constraints.

In another example, the simulation engine 124 can determine whether the sum of the concentrations of the five securities with the highest concentrations is below 60 percent, and, if the sum is below 60 percent, increase the respective concentrations until the sum is 60 percent. The simulation engine 124 can begin by determining whether the concentration of the security with the highest concentration is below 30 percent of the highest weighting. If the concentration is below 30 percent, the simulation engine 124 can increase the concentration to 30 percent, while keeping the sum of the concentrations of the five securities equal to or below 60 percent.

In another example, the simulation engine 124 can determine under which set of constraints, e.g., set A or set B, the concentrations of the component securities, e.g., both the security and the previously selected securities, can be most concentrated. For instance, if the security and the previously selected securities satisfy both sets of constraints, the data processing system can determine that set B can allow for a higher concentration of the highest weighted component securities, since set A requires that the five highest weighted component securities together comprise no more than 60 percent of the BBSI's weighting. The data processing system 102 can then prompt the user to increase the concentrations of one or more of the component securities while satisfying the boundary conditions of set B without satisfying set A.

In another example, the simulation engine 124 can use any appropriate combination of the methods described above to determine if the concentrations can be increased.

The data processing system 102 stores, in the hardware storage device 106, one or more keyed data records structured with data specifying the concentration of the security.

When at least one of the one or more concentrations 106c of the security and the one or more previously selected securities can be increased without violating the BBSI constraints, the data processing system 102 prompts, through the graphical user interface 104, the user to increase the at least one of the one or more concentrations of the security and the one or more previously selected securities. The data processing system 102 can send instructions to cause the graphical user interface 104 to display the prompt to the user. The user can select a visual representation representing a selection by the user to allow the increase of the concentrations, and the graphical user interface 104 can transmit an input representing the selection of the visual representation to the data processing system 102. For example, the prompt can include a message indicating to the user that the concentrations can be increased and a prepopulated template displaying the increased concentrations. An example of a prompt to increase concentrations is shown in FIG. 3B and described below with respect to the description of FIG. 3B.

When the user increases the at least one of the one or more concentrations of the security and the one or more previously selected securities, the data processing system 102 stores, in the hardware storage device 106, one or more keyed data records 130 structured with data specifying at least one of the one or more increased concentrations 106c.

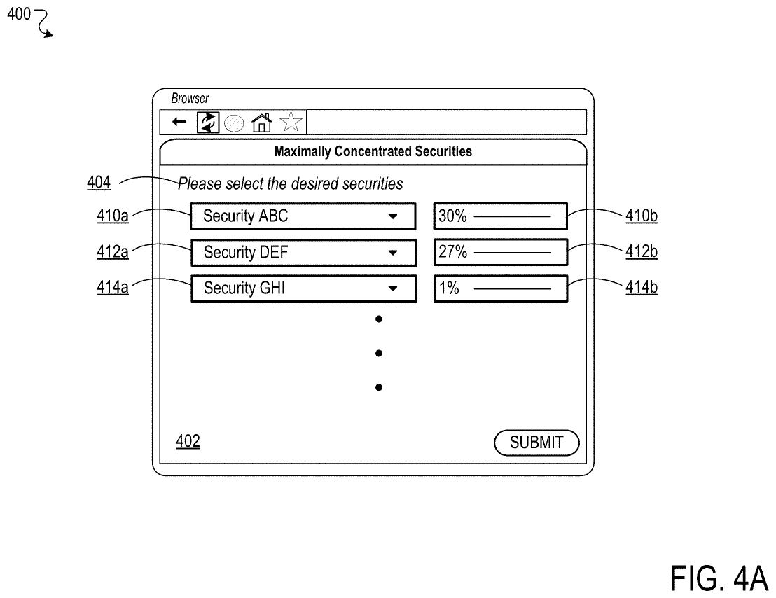

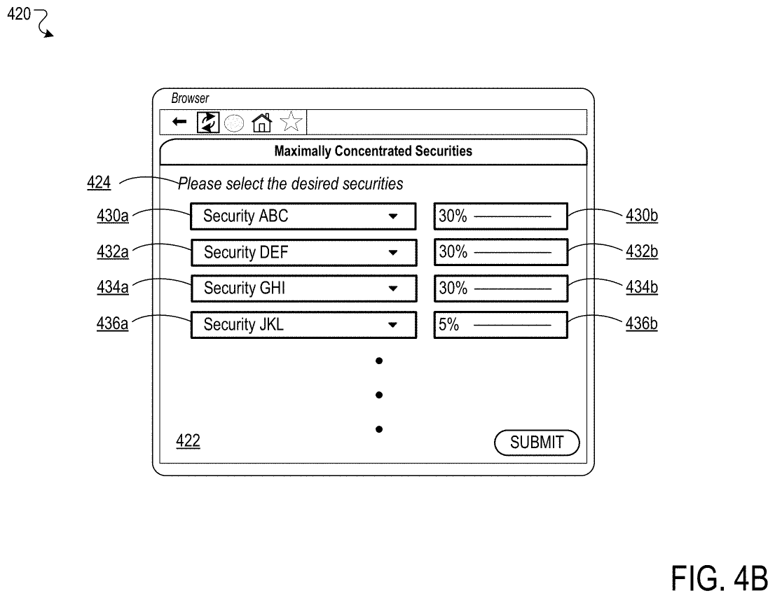

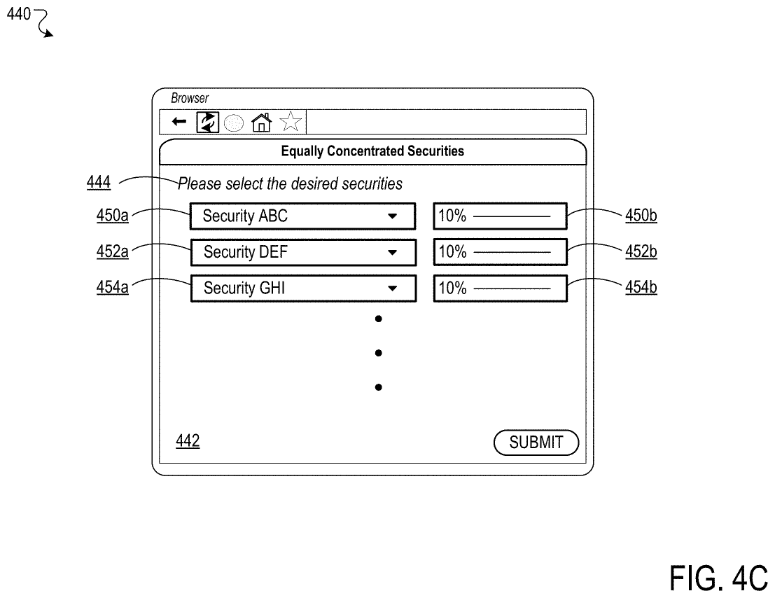

Optionally, the data processing system can prompt, through the graphical user interface 104, the user to select a prepopulated template from one or more prepopulated templates that each specifies a respective plurality of concentrations that satisfy the BBSI constraints. If the user selects a prepopulated template from the one or more prepopulated templates, the data processing system 102 can access the hardware storage device 106 the respective plurality of concentrations corresponding to the selected prepopulated template, and prompt the user, through the graphical interface, to select, for each concentration from the respective plurality of concentrations, a respective security from a predetermined list of securities. Examples of prepopulated templates shown through the graphical user interface 104 are described with respect to FIGS. 4A-B below.

The data processing system 102 can generate the predetermined list of securities to complete the portfolio 1) in a BBSI-compliant manner and 2) in a maximally concentrated manner. The data processing system 102 can generate the predetermined list of securities in accordance with the securities in the portfolio (e.g., the security and the one or more previously selected securities). For example, the system can determine a list of securities that includes securities with the same standard industrial classification score (“SIC”) code as the security previously chosen with the largest concentration, securities whose historical correlation is high with the security with the largest concentration, securities whose historical inverse correlation is high with the security with the largest concentration, or securities whose recent ADTV is high. In one example, the data processing system 102 can rank order securities according to respective ADTVs of the securities, the respective correlation coefficients, or any combination of the two.

In one example, for a portfolio subject to the BBSI constraints from set A that already includes two securities at respective concentrations of 30% and 27%, forty-three additional securities at 1% concentration each must be selected to complete the portfolio (i.e., to comply with the total concentration of the top five concentrated securities being equal to or below 60% and the requirement that each concentration be a positive integer). The system can suggest a list of securities to populate the forty-three remaining positions in order of highest correlation to the stock allocated at 30% concentration.

After the user selects the securities for the plurality of concentrations, the data processing system 102 can store one or more keyed data records structured with data specifying the selected securities and the plurality of concentrations in the hardware storage device 106.

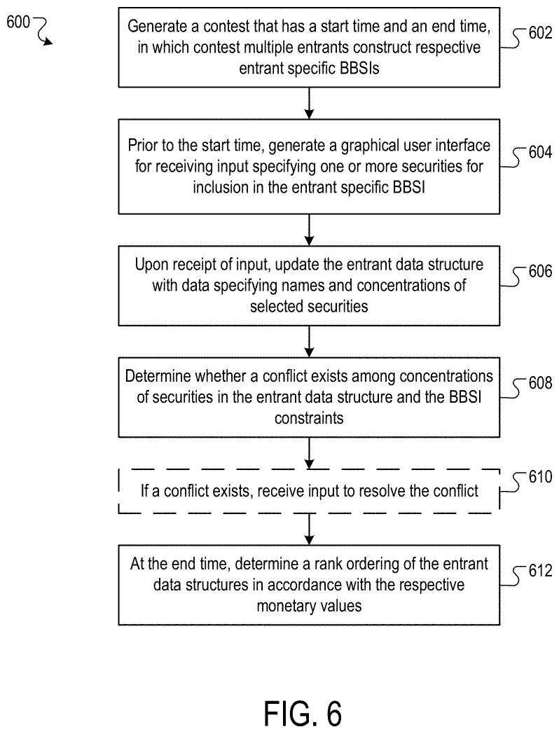

The method described above for generating a maximally concentrated, BBSI-compliant security index can be implemented in generating a contest in which multiple entrants construct one or more respective entrant-specific BBSIs. The contest can include a start time and an end time, where the entrants construct the BBSIs prior to the start time, and a rank ordering of the entrant-specific BBSIs is determined at the end time. The BBSIs can be initially constructed using a predetermined monetary budget so that each BBSI is initially of equal value. The rank ordering of entrants can be determined based on the respective monetary values at the end time. The contest is described in further detail below with respect to FIG. 6.

FIG. 2 shows an example environment 200 of a networked system for constructing a maximally concentrated security index. The networked data processing system is an example of a system implemented as computer programs on one or more computers in one or more locations in which the systems, components, and techniques described below are implemented. The environment 200 illustrates the requests for data and the data flow of the networked system, e.g., the system 100 of FIG. 1.

The environment 200 includes a data processing system 102, a graphical user interface 104 rendered on a client device 103, a hardware storage device 106, an external hardware storage device 107, and a network 202.

The data processing system 102 receives, through the graphical user interface 104, selection data 204 that is associated with a key that uniquely identifies a user. The selection data 204 can represent, e.g., a security and a concentration of the security, as described above with respect to FIG. 1. The graphical user interface 104 can be displayed on the client device 103, e.g., a computer, tablet, cell phone, or other mobile device. The client device can transmit the selection data 204 to the data processing system 102 over the network 202, e.g., the internet, a local area network (“LAN”), or wide area network (“WAN”).

The data processing system 102 transmits a request 206 for data records associated with the key to the hardware storage device 106. The data records can represent, e.g., one or more previously selected securities and one or more respective concentrations of the previously selected securities, as described above with respect to FIG. 1. For example, the hardware storage device 106 can be located locally with the data processing system 102, e.g., within the same computing device, so that the data processing system 102 transmits the request over a bus system.

In another example, the data records can be located in one or more hardware storage devices that are located remotely, e.g., in a single hardware storage device located remotely, or distributed in cloud storage, so that the data processing system 102 can transmit the request 206 for data records over the network 202.

The hardware storage device 106 receives the request 206 for data records associated with the key. In response to the request 206, the hardware storage device 106 transmits keyed data records 208 to the data processing system 102, e.g., over a bus system or the network 202, as described above. The data processing system 102 receives the data records 208.

The data processing system 102 transmits a request 210 for data structures that specify one or more sets of broad-based security index (“BBSI”) constraints, as described above with respect to FIG. 1. The data processing system 102 can transmit the request 210 to the hardware storage device 106, e.g., over a bus system or the network 202.

The hardware storage device 106 receives the request 210 for data structures. In response to the request 210, the hardware storage device 106 transmits data structures 212 to the data processing system 102, e.g., over a bus system or the network 202. The data processing system 102 receives the data structures 212.

The data processing system 102 transmits a request 214 for real time market data that includes at least, for each security in the market, a respective price history, a respective trade volume history, and a respective market capitalization, as described above with respect to FIG. 1. The data processing system 102 can transmit the request 214 to the external hardware storage device 107, e.g., over the network 202.

The hardware storage device 107 receives the request 214 for the real time market data. In response to the request 214, the external hardware storage device 107 transmits the real time market data 216 to the data processing system 102, e.g., the network 202. The data processing system 102 receives the real time market data 216.

The data processing system 102 processes the selection data 204, the data records 208, the data structures 212, and real time market data 216 to determine whether there is a conflict among the selection data 204 and the data records 208 according to the data structures 212 and real time market data 216. For example, data processing system 102 can include a parser and a simulation engine to determine if there is a conflict, as described above with reference to FIG. 1.

When there is a conflict, the data processing system 102 can prompt, through the graphical user interface 104, a user to resolve the conflict. The data processing system 102 can transmit over the network 202 instructions to cause the graphical user interface 104 to display prompt 218 to resolve the conflict. The user can select a visual representation of one or more securities and one or more respective concentrations of the securities to resolve the conflict. The client device on which the graphical user interface 104 is displayed can transmit the selection of the visual representation over the network 202 to the data processing system 102. An example of a conflict resolution prompt is shown in FIG. 3A and described below with respect to the description of FIG. 3A.

The data processing system 102 can determine whether there is any remaining conflict. When there are one or more remaining conflicts, the data processing system 102 can prompt the user through the graphical interface 104 to resolve the one or more remaining conflicts. The data processing system 102 can repeatedly prompt the user through the graphical user interface 104 until the data processing system 102 determines there is no remaining conflict.

When there is no determined conflict, the data processing system 102 can determine whether the concentration of the security or at least one of the one or more concentrations of the previously selected securities can be increased without violating the BBSI constraints. If the data processing system 102 determines that one or more of the concentrations can be increased, the data processing system 102 can prompt, through the graphical user interface 104, the user to increase the concentrations. The data processing system 104 can transmit over the network 202 instructions to the graphical user interface 104 to render prompt 220 for the user to increase concentrations. In response to receiving a selection, by the user, to increase the concentrations, the data processing system 102 can increase at least one of the concentrations, as is described above with reference to FIG. 1.

The data processing system 102 stores one or more data records 222 in the hardware storage device 106. The data processing system 102 can transmit the one or more data records 222 to the hardware storage device 106, e.g., over a bus system or the network 202. For example, the data processing system 102 can store one or more keyed data records structured with data specifying a concentration of the security. When at least one of the one or more concentrations of the previously selected securities can be increased without violating the BBSI constraints in the data structures 212 and the data processing system 102 received a selection to increase the concentrations, the data processing system 102 can store one or more keyed data records with data specifying at least one of the one or more increased concentrations.

FIG. 3A-B depict graphical user interfaces 300 and 350 (e.g., rendered on a display of a client device) rendering prompts 302 and 352 that can be shown on a graphical user interface during the construction of a security index. The graphical user interface can be displayed on a client device, e.g., a computer, tablet, cell phone, or other mobile device, and through any appropriate application, e.g., a web browser, or dedicated mobile application.

FIG. 3A depicts a graphical user interface 300 (e.g., rendered on a display of a client device) rendering a prompt 302 for conflict resolution that can be shown on a graphical user interface.

The example illustrates examples of visual representations 310a, 320a, 330a that show securities and control input areas 310b, 320b, 330b displaying respective concentrations of the securities. The user can interact with the graphical user interface 300 to select one or more securities, e.g., one at a time, and adjust the respective concentrations. The concentrations can be selected, e.g., using respective sliding bars that allow adjustment from a respective minimum value for the security to a respective maximum value for the security. The respective minimum and maximum values for each security can be determined in accordance with the BBSI constraints.

The prompt 302 can indicate one or more conflicts, and prompt the user to resolve the one or more conflicts, e.g., allowing the user to resolve the conflicts one at a time. In the example of FIG. 3, the prompt includes an exclamation point to the right of the concentration sliding bar for security 310a (“Security ABC”) to indicate that the concentration 310b (“35%”) exceeds the maximum limit set by the BBSI constraints for any single security (30% for both BBSI constraint set A and BBSI constraint set B, described above with reference to FIG. 1).

FIG. 3B depicts a graphical user interface 350 (e.g., rendered on a display of a client device) rendering a prompt 352 for increasing concentrations that can be shown on a graphical user interface.

The example illustrates examples of visual representations 360a, 370a, 380a that show securities, e.g., the security and one or more previously selected securities of FIG. 1 selected by the user, and display areas 360b, 370b, 380b displaying respective prepopulated concentrations of the securities. The user can interact with the graphical user interface 350 to select control input area 354 indicating to allow the increased security concentrations or control input area 356 indicating to disallow the increased security concentrations. The respective concentration for each security can be from a BBSI-compliant, prepopulated template.

FIGS. 4A-C depict graphical user interfaces 400, 420, and 440 rendering prepopulated templates 402, 424, and 442 that have concentrations predetermined. The prepopulated templates can be displayed on the graphical user interfaces in response to the user selecting the prepopulated template. The user can interact with the graphical user interface to select a respective security from a set of securities that are BBSI-compliant for each pre-selected concentration.

FIG. 4A illustrates graphical user interface 400 with template 402. Generally, a template includes a prompt that includes instructions for the user and a set of predefined securities from which the user can select in constructing an index. In this example, the template is a maximally concentrated template, which includes multiple predetermined concentrations that include the highest BBSI-compliant concentrations for set A constraints.

The example illustrates visual representation of a prompt 404 that presents an instruction to “Please select the desired securities”; visual representations 410a, 412a, and 414a displaying securities; and display areas 410b, 412b, and 414b showing respective predetermined concentrations. The predetermined concentrations represent a maximally concentrated security index that satisfies the BBSI constraints of set A with a highest concentration of 30%, second highest of 27%, and all remaining concentrations at 1% (i.e., to satisfy that constraint that the top five weighted securities have concentrations that sum to 60% or less).

FIG. 4B illustrates graphical user interface 420 with template 422. In this example, the template is a maximally concentrated template, which includes multiple predetermined concentrations that include the highest BBSI-compliant concentrations for set B constraints.

The example illustrates example visual representation of a prompt 424 that presents an instruction to “Please select the desired securities”; visual representations 430a, 432a, 434a, and 436a displaying securities; and display areas 430b, 432b, 434b, and 436b showing respective predetermined concentrations. The predetermined concentrations represent a maximally concentrated security index that satisfies the BBSI constraints of set B with three equal highest concentrations of 30%, a next highest of 5%, and all remaining concentrations at 1% (i.e., to satisfy the constraints that the securities have respective concentrations less than or equal to 30%, and that there are at least nine component securities).

FIG. 4C illustrates graphical user interface 440 with template 442. In this example, the template is an equally concentrated template, which includes multiple predetermined concentrations that include, exactly or approximately, equal BBSI-compliant concentrations for the securities.

The example illustrates example visual representation of a prompt 444 that presents an instruction to “Please select the desired securities”; visual representations 450a, 452a, and 454a displaying securities; and display areas 450b, 452b, and 454b showing respective predetermined concentrations. The pre-selected concentrations represent an equally concentrated security index that satisfies BBSI constraints of set A and set B. The example illustrates ten securities with equal concentrations (i.e., 10% each). Other examples can include eleven or more securities that each have exactly or approximately equal concentrations.

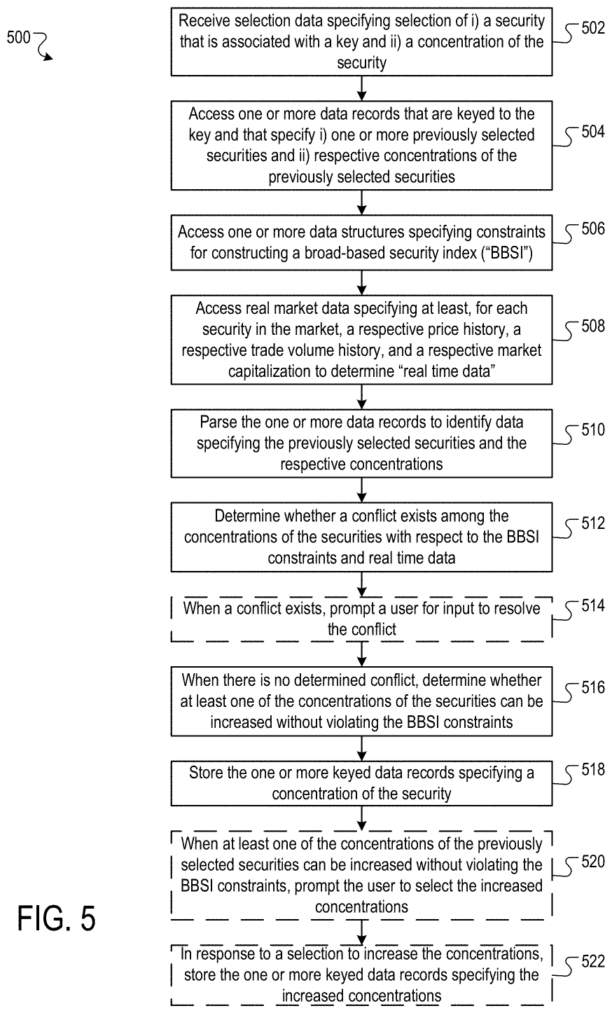

FIG. 5 is a flow diagram of an example process 500 for processing digital data to construct maximally concentrated broad-based security indices. For convenience, the process 500 will be described as being performed by a system of one or more computers located in one or more locations. For example, a system, e.g., the system 100 of FIG. 1, appropriately programmed in accordance with this specification, can perform the process 500.

The system receives selection data specifying selection of i) a security that is associated with a key and ii) a concentration of the security (502). The system can receive the selection data through a graphical user interface, e.g., a graphical user interface on a client device.

The system accesses one or more data records that are keyed to the key and that i) specify one or more previously selected securities and ii) respective concentrations of the previously selected securities (504). The system can access the one or more data records, e.g., from a hardware storage device.

The system accesses one or more data structures specifying constraints for constructing a BBSI (506). The system can access the one or more data structures, e.g., from the hardware storage device. For example, the one or more data structures can specify one or more sets of BBSI constraints, including a set A of constraints and a set B of constraints, as described with respect to FIG. 1.

The system accesses real time market data specifying at least, for each security in the market, a respective price history, a respective trade volume history, and a respective market capitalization. The system can process the real time market data to determine a respective ADTV and correlation coefficient with respect to the security for each security in the market (“real time data”) (508). The system can access the real time market data, e.g., from an external hardware storage device. For example, the system can access the real time market data to determine the real time data as described with respect to FIG. 1.

The system parses the one or more data records to identify data specifying the previously selected securities and the respective concentrations (510). The system can parse the one or more data records based on the structure of the data records. For example, the system can parse the data records using a parser located within memory in the system.

The system determines whether a conflict exists among the concentration of the security with the respective concentrations of the previously selected securities and the BBSI constraints (512). The system can determine whether a conflict exists according to each of the one or more sets of BBSI constraints in the data structures. For example, the system can use a simulation engine located within memory in the system to determine whether there is a conflict for each of the one or more BBSI constraints, as described above with respect to FIG. 1.

Optionally, when a conflict exists, the system can prompt a user for input to resolve the conflict (514). The system can prompt the user through the graphical user interface by transmitting instructions to the graphical user interface to display a visual representation of the prompt, e.g., the prompt of FIG. 3.

When there is no determined conflict, the system determines whether the concentration of the security or at least one of the concentrations of the previously selected securities can be increased without violating the BBSI constraints (516). The system can determine whether at least one of the concentrations of the security or previously selected securities can be increased, e.g., using a simulation engine located in memory. For example, the system can determine if concentrations in a BBSI-compliant prepopulated template are more concentrated than the concentrations of the security and the one or more previously selected securities.

The system stores the one or more keyed data records specifying a concentration of the security (518). For example, the system can store one or more keyed data records specifying the concentration specified by the selection data, or—if the system determines that the concentration of the security can be increased—the maximum concentration allowable by the BBSI constraints.

Optionally, when at least one of the concentrations of the security and the previously selected securities can be increased without violating the BBSI constraints, the system can prompt the user through the graphical user interface to select the increased concentrations (520). For example, the system can transmit instructions to the graphical user interface that cause the graphical user interface to display the prompt, and the user can interact with the graphical user interface to select a visual representation indicating to accept the increased concentrations or to deny the increased concentrations.

In response to a selection by the user to increase the concentrations, the system stores the one or more keyed data records specifying the increased concentrations (522). For example, the system can store the one or more keyed data records that update concentrations of previously selected securities.

FIG. 6 is a flow diagram of an example process 600 for conducting a contest. For convenience, the process 600 will be described as being performed by a system of one or more computers located in one or more locations.

Generally, the contest can include a start time and an end time, where entrants in the contest construct the BBSIs prior to the start time. The contest can include a predetermined number of contestants, a preannounced entry fee, and a preannounced prize table, e.g., where each entry in the prize table includes a respective predetermined prize. At the end time, the system can determine a numerical rank ordering of the entrant BBSIs in accordance with a respective monetary value of each entrant BBSI at the end time. The numerical rank order can be matched to the preannounced prize table, e.g., where each entry in the prize table corresponds to a numerical rank in the numerical rank ordering of the entrant BBSIs.

Entrants can include real money contestants and free play contestants. Real money contestants include contestants who meet the definition of Eligible Contract Participants (as defined in the Commodity Exchange Act Section 1a(18) and as required by Section 2(e) of the Commodity Exchange Act) will be permitted to enter contests with real money entry fees and be eligible for real money prizes. Generally, the definition for real money contestants includes contestants who have at least a minimum of $10 million invested on a discretionary basis. Free play contests include contestants who do not meet the definition of Eligible Contract Participants. Free play contestants can include contestants who have aggregate amounts of less than $10 million dollars invested on a discretionary basis. Contestants who do not meet the aforementioned standard, i.e. individuals with aggregate amounts of less than $10 million invested on a discretionary basis, will be eligible to enter contests for free. These free play contestants will not be eligible to win real money prizes, but the system will enable free players to track the performance of their indices against real money players and against broader market indices for educational purposes.

The entry fee and prize table being preannounced can enable real money contestants to enter with foreknowledge of the risk and upside of contest entry. For each entry in the contest, a real money contestant risks the entry fee to generate an entrant BBSI and can win a prize from the prize table corresponding to the numerical rank of the entrant BBSI at the end time.

The system generates a contest that has a start time and an end time, in which contest multiple entrants construct one or more respective entrant specific BBSIs (602). The system can generate one or more respective “entrant data structures” for each entrant to store in a hardware storage device. The entrant BBSIs can be initially constructed using a predetermined monetary budget so that each entrant BBSI is initially of equal value. For example, the entrant data structures can include data structured to specify the entrant, the contest, one or more securities, one or more respective concentrations of the securities, and one or more respective long or short flags for the securities.

Prior to the start time, the system generates a graphical user interface for receiving input specifying one or more securities for inclusion in the entrant specific BBSI (604). The graphical user interface is accessible before the start time and inaccessible after the start time. The one or more securities can be from a pre-specified index. For example, the system can include a data processing system that is configured to generate the graphical user interface, and the data processing system can transmit instructions to the graphical user interface that cause the graphical user interface to display a visual representation for a user to select the input, as described with respect to FIG. 1.

Upon receipt of the input, the system updates the entrant data structure with data specifying names, e.g., represented by a ticker symbol, long or short flags, and concentrations of the selected securities (606). For example, the system can parse the input to identify the names, long or short flags, and concentrations of the securities using a parser and store the data in the hardware storage device to update the entrant data structure, as described above with respect to FIG. 1.

The system determines whether a conflict exists among concentrations of securities in the entrant data structure of the BBSI constraints (608). The system can process the concentrations using a simulation engine to determine whether a conflict exists, as described with respect to FIG. 1.

Optionally, if a conflict exists, the system receives input to resolve the conflict (610). If a conflict exists, the system can receive input through a graphical user interface to resolve the conflict. For example, the system can transmit instructions to the graphical user interface that cause the graphical user interface to display, to a user, a prompt to resolve the conflict, as described with respect to FIG. 1.

At the end time, the system determines rank ordering of the entrant data structures in accordance with the respective monetary values (612). The numerical rank order can be matched to a preannounced prize table, e.g., where each entry in the table includes a predetermined prize. For each entrant data structure, the system can determine the monetary value, e.g., dollar value, of the entrant data structure as the difference between the monetary value of the securities at the end time and the monetary value of the securities at the start time.

For example, the system can determine the monetary value of each security at the start time by multiplying the concentration of the security by the predetermined monetary budget. The system can determine a quantity of each security by dividing the monetary value of the security by the price of the security at the start time. The system can determine the monetary value of each security at the end time by multiplying the quantity of the security by the price of the security at the end time. For each security, the system can determine the difference between the monetary value of the security at the end time and the monetary value of the security at the start time. If the security has a long flag, the system can determine the difference as the monetary value at the end time minus the monetary value at the start time. If the security has a short flag, the system can determine the difference as the monetary value at the start time minus the monetary value at the end time. The system can sum the differences to determine the monetary value of the entrant data structure.

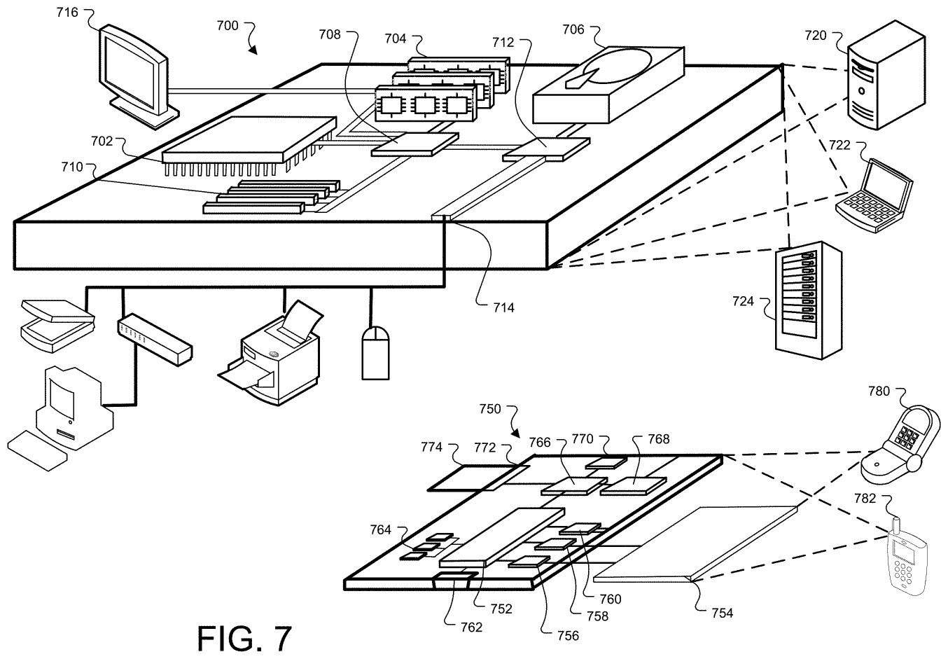

FIG. 7 is a diagram of computing devices 700 and 750 that can be used to implement a system for processing digital data to construct a maximally concentrated security index. Computing device 700 is intended to represent various forms of digital computers, such as laptops, desktops, workstations, personal digital assistants, servers, blade servers, mainframes, and other appropriate computers. Computing device 750 is intended to represent various forms of mobile devices, such as personal digital assistants, cellular telephones, smartphones, and other similar computing devices. Additionally, computing device 700 or 750 can include Universal Serial Bus (USB) flash drives. The USB flash drives can store operating systems and other applications. The USB flash drives can include input/output components, such as a wireless transmitter or USB connector that can be inserted into a USB port of another computing device. The components shown here, their connections and relationships, and their functions, are meant to be exemplary only, and are not meant to limit implementations of the inventions described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and can be mounted on a common motherboard or in other manners as appropriate. The processor 702 can process instructions for execution within the computing device 700, including instructions stored in the memory 704 or on the storage device 708 to display graphical information for a graphical user interface (“GUI”) on an external input/output device, such as display 716 coupled to high speed interface 708. In other implementations, multiple processors and/or multiple buses can be used, as appropriate, along with multiple memories and types of memory. Also, multiple computing devices 700 can be connected, with each device providing portions of the necessary operations, for example, as a server bank, a group of blade servers, or a multi-processor system.

The memory 704 stores information within the computing device 700. In one implementation, the memory 704 is a volatile memory unit or units. In another implementation, the memory 704 is a non-volatile memory unit or units. The memory 704 can also be another form of computer-readable medium, such as a magnetic or optical disk.

The storage device 708 is capable of providing mass storage for the computing device 700. In one implementation, the storage device 708 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The information carrier is a computer- or machine-readable medium, such as the memory 704, the storage device 708, or memory on processor 702.

The high speed controller 708 manages bandwidth-intensive operations for the computing device 700, while the low speed controller 712 manages lower bandwidth intensive operations. Such allocation of functions is exemplary only. In one implementation, the high-speed controller 708 is coupled to memory 704, display 716, for example, through a graphics processor or accelerator, and to high-speed expansion ports 710, which can accept various expansion cards (not shown). In the implementation, low-speed controller 712 is coupled to storage device 708 and low-speed expansion port 714. The low-speed expansion port, which can include various communication ports, for example, USB, Bluetooth, Ethernet, wireless Ethernet can be coupled to one or more input/output devices, such as a keyboard, a pointing device, microphone/speaker pair, a scanner, or a networking device such as a switch or router, for example, through a network adapter. The computing device 700 can be implemented in a number of different forms, as shown in FIG. 7. For example, it can be implemented as a standard server 720, or multiple times in a group of such servers. It can also be implemented as part of a rack server system 724. In addition, it can be implemented in a personal computer such as a laptop computer 722. Alternatively, components from computing device 700 can be combined with other components in a mobile device (not shown), such as device 750. Each of such devices can contain one or more of computing device 700, 750, and an entire system can be made up of multiple computing devices 700, 750 communicating with each other.

The computing device 700 can be implemented in a number of different forms, as shown in FIG. 7. For example, it can be implemented as a standard server 720, or multiple times in a group of such servers. It can also be implemented as part of a rack server system 724. In addition, it can be implemented in a personal computer such as a laptop computer 722. Alternatively, components from computing device 700 can be combined with other components in a mobile device (not shown), such as device 750. Each of such devices can contain one or more of computing device 700, 750, and an entire system can be made up of multiple computing devices 700, 750 communicating with each other.

Computing device 750 includes a processor 752, memory 764, and an input/output device such as a display 754, a communication interface 766, and a transceiver 768, among other components. The device 750 can also be provided with a storage device, such as a micro-drive or other device, to provide additional storage. Each of the components 750, 752, 764, 754, 766, and 768, are interconnected using various buses, and several of the components can be mounted on a common motherboard or in other manners as appropriate.

The processor 752 can execute instructions within the computing device 750, including instructions stored in the memory 764. The processor can be implemented as a chipset of chips that include separate and multiple analog and digital processors. Additionally, the processor can be implemented using any of a number of architectures. For example, the processor 710 can be a CISC (Complex Instruction Set Computers) processor, a RISC (Reduced Instruction Set Computer) processor, or a MISC (Minimal Instruction Set Computer) processor. The processor can provide, for example, for coordination of the other components of the device 750, such as control of user interfaces, applications run by device 750, and wireless communication by device 750.

Processor 752 can communicate with a user through control interface 758 and display interface 756 coupled to a display 754. The display 754 can be, for example, a TFT (Thin-Film-Transistor Liquid Crystal Display) display or an OLED (Organic Light Emitting Diode) display, or other appropriate display technology. The display interface 756 can comprise appropriate circuitry for driving the display 754 to present graphical and other information to a user. The control interface 758 can receive commands from a user and convert them for submission to the processor 752. In addition, an external interface 762 can be provide in communication with processor 752, so as to enable near area communication of device 750 with other devices. External interface 762 can provide, for example, for wired communication in some implementations, or for wireless communication in other implementations, and multiple interfaces can also be used.

The memory 764 stores information within the computing device 750. The memory 764 can be implemented as one or more of a computer-readable medium or media, a volatile memory unit or units, or a non-volatile memory unit or units. Expansion memory 774 can also be provided and connected to device 750 through expansion interface 772, which can include, for example, a SIMM (Single In Line Memory Module) card interface. Such expansion memory 774 can provide extra storage space for device 750, or can also store applications or other information for device 750. Specifically, expansion memory 774 can include instructions to carry out or supplement the processes described above, and can include secure information also. Thus, for example, expansion memory 774 can be provide as a security module for device 750, and can be programmed with instructions that permit secure use of device 750. In addition, secure applications can be provided via the SIMM cards, along with additional information, such as placing identifying information on the SIMM card in a non-hackable manner.

The memory can include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, or memory on processor 752 that can be received, for example, over transceiver 768 or external interface 762.

Device 750 can communicate wirelessly through communication interface 766, which can include digital signal processing circuitry where necessary. Communication interface 766 can provide for communications under various modes or protocols, such as GSM voice calls, SMS, EMS, or MMS messaging, CDMA, TDMA, PDC, WCDMA, CDMA2000, or GPRS, among others. Such communication can occur, for example, through radio-frequency transceiver 768. In addition, short-range communication can occur, such as using a Bluetooth, Wi-Fi, or other such transceiver (not shown). In addition, GPS (Global Positioning System) receiver module 770 can provide additional navigation- and location-related wireless data to device 750, which can be used as appropriate by applications running on device 750.

Device 750 can also communicate audibly using audio codec 760, which can receive spoken information from a user and convert it to usable digital information. Audio codec 760 can likewise generate audible sound for a user, such as through a speaker, for example, in a handset of device 750. Such sound can include sound from voice telephone calls, can include recorded sound, for example, voice messages, music files, etc. and can also include sound generated by applications operating on device 750.

The computing device 750 can be implemented in a number of different forms, as shown in FIG. 7. For example, it can be implemented as a cellular telephone 780. It can also be implemented as part of a smartphone 782, personal digital assistant, or other similar mobile device.

Embodiments of the subject matter and the functional operations described in this specification can be implemented in digital electronic circuitry, tangibly-embodied computer software or firmware, computer hardware (including the structures disclosed in this specification and their structural equivalents), or in combinations of one or more of them. Embodiments of the subject matter described in this specification can be implemented as one or more computer programs (i.e., one or more modules of computer program instructions encoded on a tangible non-transitory program carrier for execution by, or to control the operation of, data processing apparatus). The computer storage medium can be a machine-readable storage device, a machine-readable storage substrate, a random or serial access memory device, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document, in a single file dedicated to the program in question, or in multiple coordinated files (e.g., files that store one or more modules, sub-programs, or portions of code)). A computer program can be deployed so that the program is executed on one computer or on multiple computers that are located at one site or distributed across multiple sites and interconnected by a data communication network.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data (e.g., magnetic, magneto-optical disks, or optical disks), however, a computer need not have such devices.

Computer-readable media suitable for storing computer program instructions and data include all forms of non-volatile memory on media and memory devices, including by way of example semiconductor memory devices (e.g., EPROM, EEPROM, and flash memory devices), magnetic disks (e.g., internal hard disks or removable disks), magneto-optical disks, and CD-ROM and DVD-ROM disks. The processor and the memory can be supplemented by, or incorporated in, special purpose logic circuitry.

1. A method implemented by a data processing system, comprising:
receiving, through a graphical user interface, selection data specifying selection of a visual representation of a security and further specifying a concentration of the security, with the selection data being associated with a key that uniquely identifies a user associated with the selection data;
accessing, from a hardware storage device, one or more data records that are keyed to the key, with the one or more data records structured to specify one or more previously selected securities and one or more respective concentrations of the one or more previously selected securities;
accessing, from the hardware storage device, one or more data structures specifying a plurality of constraints for constructing a broad-based security index (index or “BBSI”);
parsing, by a parser of the data processing system, the one or more data records to identify, based on the structure, data specifying the one or more previously selected securities and data specifying the one or more respective concentrations;
based on the parsed data, determining, by the data processing system, whether a conflict exists among the concentration of the security with respective concentrations of the previously selected securities and the BBSI constraints;
when a conflict exists, prompting, through the graphical user interface, a user for input to resolve the conflict;
when there is no determined conflict,
determining whether the concentration of the security or at least one of the one or more concentrations of the previously selected securities can be increased, relative to an original concentration of the security, without violating the BBSI constraints;
storing, in the hardware storage device, the one or more keyed data records structured with data specifying a concentration of the security;
when at least one of the one or more concentrations of the security and the one or more previously selected securities can be increased without violating the BBSI constraints,
prompting, through the graphical user interface, the user to increase the at least one of the one or more concentrations of the security and the one or more previously selected securities; and
when the user selects to increase the at least one of the one or more concentrations of the security and the one or more previously selected securities,
storing, in the hardware storage device, the one or more keyed data records structured with data specifying at least one of the one or more increased concentrations.

2. The method of claim 1, wherein the BBSI constraints specify:
the BBSI has ten or more component securities;
no single component security comprises more than 30 percent of the index's weighting;
the five highest weighted component securities together comprise no more than 60 percent of the index's weighting; and
the lowest weighted component securities comprising, in the aggregate, 25 percent of the index's weighting have an aggregate dollar value of average daily trading volume (ADTV) of $50 million or more (or in the case of an index with 15 or more component securities, $30 million or more).

3. The method of claim 1, further comprising:
generating, by the data processing system, a contest in which a plurality of entrants construct respective entrant specific BBSIs, with each entrant corresponding to one or more data structures (“entrant data structures”) stored in a hardware storage device, wherein the contest has a start time, an end time, and a predetermined monetary budget for the entrant specific BBSIs, wherein the method includes:
prior to the start time, generating, by the data processing system, a graphical user interface with a plurality of input controls for receiving input specifying one or more securities from a pre-specified selection universe for inclusion in the entrant specific BBSI, with the graphical user interface being accessible before the start time and being inaccessible after the start time; and
for a particular entrant data structure,
upon receipt of input from the input controls, updating the entrant data structure with data specifying names of selected securities and concentrations of selected securities;
determining whether a conflict exists among concentrations of securities in the entrant data structure and the BBSI constraints; and
if a conflict exists, receiving input to resolve the conflict; and
at the end time, determining a rank ordering of the entrant data structures in accordance with respective monetary values of the entrant data structures.

4. The method of claim 3, further comprising:
causing rendering, on a client device, of one or more graphical user interfaces with one or more visual representations of results of free play contestants or real money contestants, with a real money contestant being an entrant that is a retail player who meets the definition of Eligible Contract Participant (as defined in the Commodity Exchange Act Section 1a(18) and as required by Section 2(e) of the Commodity Exchange Act) and who will be permitted to enter contests with real money entry fees and be eligible for real money prizes (i.e., contestants who have at least a minimum of $10 million invested on a discretionary basis) and with a free play contestant being an entrant that is a retail player who does not meet the definition of Eligible Contract Participant (as defined in the Commodity Exchange Act Section 1a(18) and as required by Section 2(e) of the Commodity Exchange Act) and who will not be permitted to enter contests with real money entry fees nor be eligible for real money prizes (i.e., contestants who do not have at least a minimum of $10 million invested on a discretionary basis).

5. The method of claim 1, wherein the BBSI constraints specify:
the BBSI has nine or more component securities;
no single component security comprises more than 30 percent of the index's weighting;
all of the component securities are registered under section 12 of the Exchange Act; and
each component security is both one of the 750 securities with the largest market capitalization and one of the 675 component securities with the largest dollar value of the average daily trading volume (“ADTV”).

6. The method of claim 1, further comprising:
prompting, through the graphical user interface, the user to select a prepopulated template from one or more prepopulated templates, where each prepopulated template of the one or more prepopulated templates specifies a plurality of concentrations for completing a BBSI for the user and that satisfy the constraints for constructing a BBSI; and
if the user selects the prepopulated template:
accessing, from the hardware storage device, a plurality of data records that are structured to specify the plurality of concentrations and, for each of the plurality of concentrations, a respective security that is to be selected by the user;
prompting the user, through the graphical user interface, to select, for each of the plurality of concentrations, a respective security for the concentration from a set of securities that satisfy the BBSI constraints;
receiving, through the graphical user interface, selection data specifying selection of a visual representation of the selected respective securities, with the selection data being associated with the key that uniquely identifies the user associated with the selection data;
parsing, by the parser of the data processing system, the plurality of data records to identify, based on the structure, data specifying the selected respective securities and data specifying the plurality of concentrations; and
storing, in the hardware storage device, the plurality of keyed data records structured with data specifying the plurality of selected securities and the plurality of concentrations.

7. The method of claim 6, wherein the one or more prepopulated templates include one or more maximally concentrated templates.

8. The method of claim 7, wherein the one or more prepopulated templates include one or more equally concentrated templates.

9. The method of claim 1, further comprising:
accessing, from an external hardware storage device, real time market data specifying at least, for each security in a security market, a respective price history, a respective trade volume history, and a respective market capitalization;
processing the real time market data to determine, for each security in the security market, a respective average daily trading volume (“ADTV”) for the security and a respective correlation coefficient for the security with respect to at least one of the security and the one or more previously selected securities (“real time data”); and
based on the parsed data and the real time data, determining, by the data processing system, whether a conflict exists among the concentration of the security with respective concentrations of the previously selected securities and the BBSI constraints.

10. A system comprising:
one or more computers; and
one or more storage devices storing instructions that, when executed by the one or more computers, cause the one or more computers to perform operations for constructing a maximally concentrated broad-based security index, the operations comprising:
receiving, through a graphical user interface, selection data specifying selection of a visual representation of a security and further specifying a concentration of the security, with the selection data being associated with a key that uniquely identifies a user associated with the selection data;
accessing, from a hardware storage device, one or more data records that are keyed to the key, with the one or more data records structured to specify one or more previously selected securities and one or more respective concentrations of the one or more previously selected securities;
accessing, from the hardware storage device, one or more data structures specifying a plurality of constraints for constructing a broad-based security index (index or “BBSI”);
parsing, by a parser of the data processing system, the one or more data records to identify, based on the structure, data specifying the one or more previously selected securities and data specifying the one or more respective concentrations;
based on the parsed data, determining, by the data processing system, whether a conflict exists among the concentration of the security with respective concentrations of the previously selected securities and the BBSI constraints;
when a conflict exists, prompting, through the graphical user interface, a user for input to resolve the conflict;
when there is no determined conflict,
determining whether the concentration of the security or at least one of the one or more concentrations of the previously selected securities can be increased, relative to an original concentration of the security, without violating the BBSI constraints;
storing, in the hardware storage device, the one or more keyed data records structured with data specifying a concentration of the security;
when at least one of the one or more concentrations of the security and the one or more previously selected securities can be increased without violating the BBSI constraints,
prompting, through the graphical user interface, the user to increase the at least one of the one or more concentrations of the security and the one or more previously selected securities; and
when the user selects to increase the at least one of the one or more concentrations of the security and the one or more previously selected securities,
storing, in the hardware storage device, the one or more keyed data records structured with data specifying at least one of the one or more increased concentrations.

11. The system of claim 10, wherein the BBSI constraints specify:
the BBSI has ten or more component securities;
no single component security comprises more than 30 percent of the index's weighting;
the five highest weighted component securities together comprise no more than 60 percent of the index's weighting; and
the lowest weighted component securities comprising, in the aggregate, 25 percent of the index's weighting have an aggregate dollar value of average daily trading volume (ADTV) of $50 million or more (or in the case of an index with 15 or more component securities, $30 million or more).

12. The system of claim 10, further comprising:
generating, by the data processing system, a contest in which a plurality of entrants construct respective entrant specific BBSIs, with each entrant corresponding to one or more data structures (“entrant data structures”) stored in a hardware storage device, wherein the contest has a start time, an end time, and a predetermined monetary budget for the entrant specific BBSIs, wherein the method comprises:
prior to the start time, generating, by the data processing system, a graphical user interface with a plurality of input controls for receiving input specifying one or more securities from a pre-specified selection universe for inclusion in the entrant specific BBSI, with the graphical user interface being accessible before the start time and being inaccessible after the start time; and
for a particular entrant data structure,
upon receipt of input from the input controls, updating the entrant data structure with data specifying names of selected securities and concentrations of selected securities;
determining whether a conflict exists among concentrations of securities in the entrant data structure and the BBSI constraints; and
if a conflict exists, receiving input to resolve the conflict; and
at the end time, determining a rank ordering of the entrant data structures in accordance with respective monetary values of the entrant data structures.

13. The system of claim 12, further comprising:
causing rendering, on a client device, of one or more graphical user interfaces with one or more visual representations of results of free play contestants or real money contestants, with a real money contestant being an entrant that is a retail player who meets the definition of Eligible Contract Participant (as defined in the Commodity Exchange Act Section 1a(18) and as required by Section 2(e) of the Commodity Exchange Act) and who will be permitted to enter contests with real money entry fees and be eligible for real money prizes (i.e., contestants who have at least a minimum of $10 million invested on a discretionary basis) and with a free play contestant being an entrant that is a retail player who does not meet the definition of Eligible Contract Participant (as defined in the Commodity Exchange Act Section 1a(18) and as required by Section 2(e) of the Commodity Exchange Act) and who will not be permitted to enter contests with real money entry fees nor be eligible for real money prizes (i.e., contestants who do not have at least a minimum of $10 million invested on a discretionary basis).

14. The system of claim 10, wherein the BBSI constraints specify:
the BBSI has nine or more component securities;
no single component security comprises more than 30 percent of the index's weighting;
all of the component securities are registered under section 12 of the Exchange Act; and
each component security is both one of the 750 securities with the largest market capitalization and one of the 675 component securities with the largest dollar value of the average daily trading volume (“ADTV”).

15. The system of claim 10, further comprising:
prompting, through the graphical user interface, the user to select a prepopulated template from one or more prepopulated templates, where each prepopulated template of the one or more prepopulated templates specifies a plurality of concentrations for completing a BBSI for the user and that satisfy the constraints for constructing a BBSI; and
if the user selects the prepopulated template:
accessing, from the hardware storage device, a plurality of data records that are structured to specify the plurality of concentrations and, for each of the plurality of concentrations, a respective security that is to be selected by the user;
prompting the user, through the graphical user interface, to select, for each of the plurality of concentrations, a respective security for the concentration from a set of securities that satisfy the BBSI constraints;
receiving, through the graphical user interface, selection data specifying selection of a visual representation of the selected respective securities, with the selection data being associated with the key that uniquely identifies the user associated with the selection data;
parsing, by the parser of the data processing system, the plurality of data records to identify, based on the structure, data specifying the selected respective securities and data specifying the plurality of concentrations; and
storing, in the hardware storage device, the plurality of keyed data records structured with data specifying the plurality of selected securities and the plurality of concentrations.

16. The system of claim 15, wherein the one or more prepopulated templates includes a maximally concentrated template.

17. The system of claim 16, wherein the one or more prepopulated templates includes an equally concentrated template.

18. The system of claim 10, further comprising:
accessing, from an external hardware storage device, real time market data specifying at least, for each security in a security market, a respective price history, a respective trade volume history, and a respective market capitalization;
processing the real time market data to determine, for each security in the security market, a respective average daily trading volume (“ADTV”) for the security and a respective correlation coefficient for the security with respect to at least one of the security and the one or more previously selected securities (“real time data”); and
based on the parsed data and the real time data, determining, by the data processing system, whether a conflict exists among the concentration of the security with respective concentrations of the previously selected securities and the BBSI constraints.

19. One or more non-transitory computer storage media storing instructions that when executed by one or more computers cause the one or more computers to perform operations for constructing a maximally concentrated broad-based security index, the operations comprising:
receiving, through a graphical user interface, selection data specifying selection of a visual representation of a security and further specifying a concentration of the security, with the selection data being associated with a key that uniquely identifies a user associated with the selection data;
accessing, from a hardware storage device, one or more data records that are keyed to the key, with the one or more data records structured to specify one or more previously selected securities and one or more respective concentrations of the one or more previously selected securities;
accessing, from the hardware storage device, one or more data structures specifying a plurality of constraints for constructing a broad-based security index (index or “BBSI”);
parsing, by a parser of the data processing system, the one or more data records to identify, based on the structure, data specifying the one or more previously selected securities and data specifying the one or more respective concentrations;
based on the parsed data, determining, by the data processing system, whether a conflict exists among the concentration of the security with respective concentrations of the previously selected securities and the BBSI constraints;
when a conflict exists, prompting, through the graphical user interface, a user for input to resolve the conflict;
when there is no determined conflict,
determining whether the concentration of the security or at least one of the one or more concentrations of the previously selected securities can be increased, relative to an original concentration of the security, without violating the BBSI constraints;
storing, in the hardware storage device, the one or more keyed data records structured with data specifying a concentration of the security;
when at least one of the one or more concentrations of the security and the one or more previously selected securities can be increased without violating the BBSI constraints,
prompting, through the graphical user interface, the user to increase the at least one of the one or more concentrations of the security and the one or more previously selected securities; and
when the user selects to increase the at least one of the one or more concentrations of the security and the one or more previously selected securities,
storing, in the hardware storage device, the one or more keyed data records structured with data specifying at least one of the one or more increased concentrations.

20. The one or more non-transitory computer storage media of claim 19, further comprising:
generating, by the one or more computers, a contest in which a plurality of entrants construct respective entrant specific BBSIs, with each entrant corresponding to one or more data structures (“entrant data structures”) stored in a hardware storage device, wherein the contest has a start time, an end time, and a predetermined monetary budget for the entrant specific BBSIs, wherein the method comprises:
prior to the start time, generating, by the data processing system, a graphical user interface with a plurality of input controls for receiving input specifying one or more securities from a pre-specified selection universe for inclusion in the entrant specific BBSI, with the graphical user interface being accessible before the start time and being inaccessible after the start time; and
for a particular entrant data structure,
upon receipt of input from the input controls, updating the entrant data structure with data specifying names of selected securities and concentrations of selected securities;
determining whether a conflict exists among concentrations of securities in the entrant data structure and the BBSI constraints; and
if a conflict exists, receiving input to resolve the conflict; and
at the end time, determining a rank ordering of the entrant data structures in accordance with respective monetary values of the entrant data structures.

21. A user-constructed BBSI product for a relative performance swap or a contest, the user-constructed BBSI product produced by:
rendering, by a data processing system, a graphical user interface with a plurality of input controls for receiving input specifying selection of one or more securities from a plurality of securities for inclusion in the user-constructed BBSI product;
upon receipt of input from one or more of the input controls, generating a data structure with data representing one or more names of one or more selected securities and further representing one or more concentrations of the one or more selected securities, with the data structure representing the user-constructed BBSI product;
determining whether a conflict exists among the one or more concentrations of the one or more securities and one or more BBSI constraints;
if a conflict exists, receiving input to resolve the conflict; and
storing, in memory, the data structure representing the user-constructed BBSI product, with the data structure including data representing the one or more names of one or more selected securities and further representing (i) the one or more concentrations of the one or more selected securities, or (ii) one or more updated concentrations of the one or more selected security, with the one or more updated concentrations based on the received input to resolve the conflict.

22. One or more hardware storage devices for generating a user-constructed BBSI product, the one or more hardware storage devices storing instructions that are executable by one or more processors to perform operations including:
storing, in memory, a data structure representing the user-constructed BBSI product (“index product”), wherein the data structure includes data representing one or more names of user-selected securities and further representing concentrations of the user-selected securities, wherein the concentrations and the user-selected securities satisfy BBSI constraints, with the BBSI constraints being a set of first constraints and/or a set of second constraints, wherein the concentrations of the user-selected securities are maximized without violating the BBSI constraints;
wherein the set of first constraints specify that i) the index product has ten or more component securities, ii) no single component security comprises more than 30 percent of the weighting of the index product, iii) the five highest weighted component securities together comprise no more than 60 percent of the weighting of the index product, and iv) either the lowest weighted component securities comprising, in the aggregate, 25 percent of the weighting of the index product have an aggregate dollar value of average daily trading volume (“ADTV”) of $50 million or more, or, in the case of an index product with 15 or more component securities, $30 million or more; and
wherein the set second of constraints specify that i) the index product has nine or more component securities, ii) no single component security comprises more than 30 percent of the weighting of the index product, iii) all of the component securities are registered under section 12 of the Exchange Act, and iv) each component security is both one of the 750 securities with the largest market capitalization and one of the 675 component securities with the largest dollar value of the ADTV.
